(19) United States
(12) Patent Application Publication
(10) Pub. No.: US 2003/0133663 A1
(43) Pub. Date: Jul. 17, 2003

(54) Integrated optical splitter

(75) Inventors: Xavier Orignac, Bruchsal (DE); Wolfgang Foss, Kronau (DE)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/341,896

(22) Filed: Jan. 14, 2003

Related U.S. Application Data
(60) Provisional application No. 60/349,031, filed on Jan. 16, 2002.

(51) Int. Cl. G02B 6/26

(52) U.S. Cl. 385/45; 385/48

(57) ABSTRACT

The invention relates to an integrated waveguide optical tap coupler, which includes an input waveguide, a tapered section, and a pair of output waveguides. The upper edges of the tapered section and one of the output waveguides defines an arc of a circle with a first radius, while the lower edges of the tapered section and the other output waveguide defines an arc of a circle with a second radius. The proximate ends of the two output waveguides are separated by a truncated wedge tip defining a distance S. With this arrangement excess loss is reduced by ensuring the wavefront is continuously tilted and the branching angles are very small.

### CROSS-REFERENCE TO RELATED APPLICATIONS

The present invention claims priority from U.S. Patent Application No. 60/349,031 filed Jan. 16, 2002.

### TECHNICAL FIELD

The present invention relates to optical splitters, and in particular to integrated optical tap couplers with controllable splitting ratios.

### BACKGROUND OF THE INVENTION

The mode splitting properties of integrated branching waveguides has long been studied in an effort to obtain a controllable optical splitting device exhibiting low polarization and wavelength dependencies. In U.S. Pat. No. 3,920,314 issued on Nov. 18, 1975 to Yajima, (See FIG. 1) a discussion of asymmetric (when the two output waveguides O₁₁ and O₁₂ have different angles relative to the input waveguide I₁) and asynchronous (when the two output waveguides have different propagation constants) output waveguides is provided. Unfortunately, the Yajima device includes a sharp corner D₁, which causes wave front discontinuity. Moreover, the wedge tip T₁ is pointed, which is disadvantages for reasons that will be described hereinafter.

Since then different variations of these two properties have been examined to determine the advantages and disadvantages thereof, e.g. asymmetrical with synchronous, symmetrical with synchronous, symmetric with asynchronous, asymmetrical with asynchronous. Further studies have also been conducted into the effect of changing the branching angle between the input and output waveguides.

Z Weissman et al in Optics Letters, vol. 14, No. 5 Mar. 1, 1989, pp 293 to 295, disclosed the details of a study into the effects of having output waveguides O₂₁ and O₂₂ with unequal widths and with tapering (See FIG. 2).

With reference to FIG. 3, U.S. Pat. No. 5,127,081 issued Jun. 30, 1992 to Uziel Koren and Kang-Yih Liou discloses an asymmetric and asynchronous Y-branch device providing a controllable polarization-independent power splitting ratio. The power splitting ratio is controlled by the branching angle θ and the widths D₁, D₂, W₁, and W₂ of the output branches O₃₁ and O₃₂. The Liou et al device includes a truncated wedge tip T₃, but also includes a discontinuity D₃.

U.S. Pat. No. 5,524,156 issued Jun. 4, 1996 to Van der Tol discloses an asymmetric asynchronous splitter, which is polarization and wavelength independent. The Van der Tol device includes a discontinuity D₄ (See FIG. 4) in the input waveguide 14, which introduces some mode conversion between the modes of different orders. The amount of mode conversion is determined by the geometrical parameters of the discontinuity.

With reference to FIG. 5, U.S. Pat. No. 5,590,226 issued Dec. 31, 1996 to Barbara Wolf et al discloses a controllable splitter including a discontinuity D₅ between a mono-modal input waveguide I₅ and symmetrical output waveguides O₅₁ and O₅₂. The discontinuity D₅ is responsible for mode conversion between the guided mode and the radiation modes. Since they have different propagation constants, they interfere along the propagation direction, so that the optical energy is not symmetrically distributed at the branching point. Therefore, the symmetric and anti-symmetric modes of the two output waveguides are unevenly excited, resulting in a given splitting ratio. However, the resulting splitting ratio is wavelength dependent.

Another asymmetric splitter is disclosed in U.S. Pat. No. 6,236,784 issued May 22, 2001 to Tatemi Ido. As illustrated in FIG. 6, the two output waveguides 0₆₁ and 0₆₂ are symmetrical and synchronous: however, asymmetry results from an asymmetric multimode section MM₆ disposed between the input 16 and the two output waveguides 0₆₁ and 0₆₂.

An object of the present invention is to overcome the shortcomings of the prior art by providing an integrated optical splitter with low wavelength dependent loss (WDL) and low polarization dependent loss (PDL). Moreover, the device of the present invention includes a plurality of independent parameters providing the flexibility necessary to obtain desired splitting ratios, while having the robustness to overcome technological fluctuations.

### SUMMARY OF THE INVENTION

Accordingly, the present invention relates to an integrated optical splitter device comprising:

an input waveguide for launching an optical signal defined by a wave front;

a first output waveguide for outputting a first portion of the optical signal, the first output waveguide having a first width;

a second output waveguide for outputting a second portion of the optical signal, the second output waveguide having a second width less than the first width;

a tapered section having an input end coextensive with an end of the input waveguide, and an output end optically coupled to the first and second output waveguides, the output end of the tapered section being wider than the first and the second waveguides combined forming a truncated wedge tip therebetween;

wherein a first outer edge of the tapered section and an outer edge of the first output waveguide define a first arc; and

wherein a second outer edge of the tapered section and an outer edge of the second output waveguide define a second arc;

whereby the wave front is continually tilted during propagation through the device.

### BRIEF DESCRIPTION OF THE DRAWINGS

The invention will be described in greater detail with reference to the accompanying drawings which represent preferred embodiments thereof, wherein:

FIG. 1 illustrates a conventional optical splitter;

FIG. 2 illustrates another conventional optical splitter;

FIG. 3 illustrates a third conventional optical splitter;

FIG. 4 illustrates a conventional optical splitter including a discontinuity;

FIG. 5 illustrates another conventional optical splitter including a different discontinuity;

FIG. 6 illustrates a conventional optical splitter with an asymmetric intermediate portion;

FIG. 7 illustrates a optical splitter according to the present invention;

FIGS. 8a and 8b illustrate some of the various parameters used to define the optical splitter of FIG. 7;

FIG. 9 illustrates some of the various parameters used to define the optical splitter of FIG. 7;

FIG. 10 is a plot used to transform a two-dimensional profile into a one-dimensional effective index profile;

FIG. 11 is a plot of W_{wide} vs the fraction of power in the narrower waveguide for a W_{arrow} of 2 μm;

FIG. 12 is a plot of W_{wide} vs the fraction of power in the narrower waveguide for a

FIG. 13 is a plot of Excess Loss (dB) vs Fraction of Power in the narrower waveguide;

FIG. 14 is a plot of PDL in the narrower waveguide vs Fraction of Power in the narrower waveguide;

FIG. 15 is a plot of PDL in the wider arm vs Fraction of Power in the wider waveguide; and

FIG. 16 is a plot of Wavelength vs Fraction of Power in the narrower waveguide.

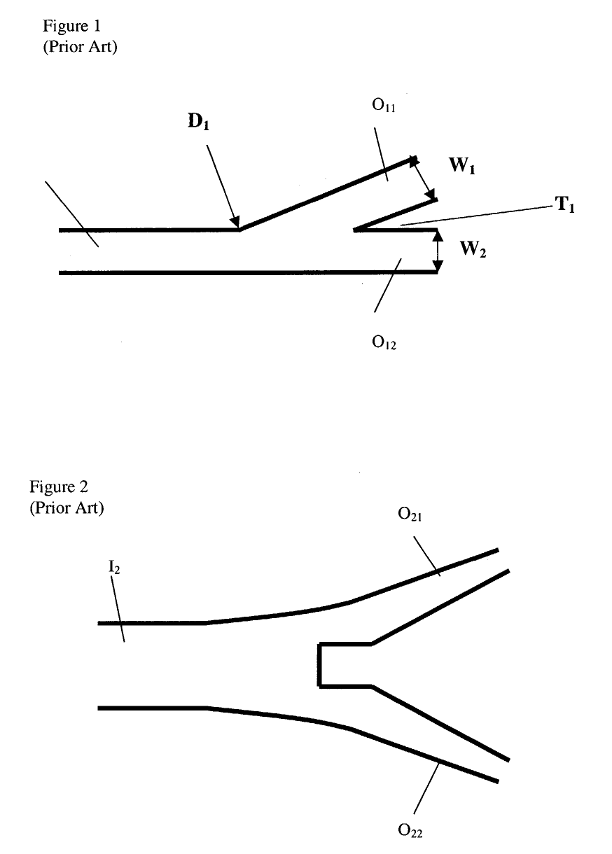

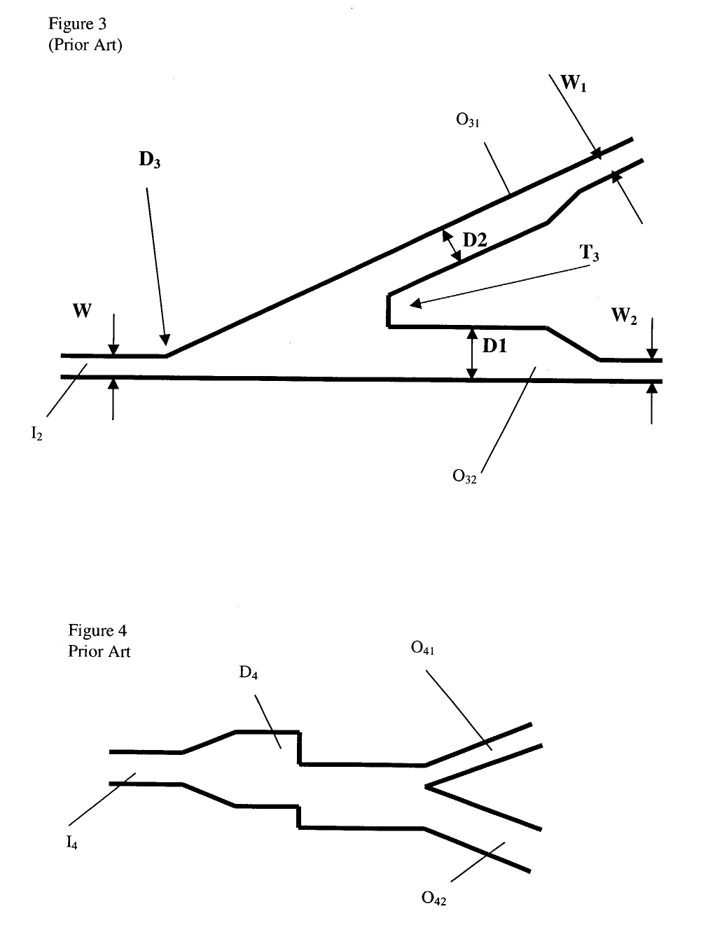

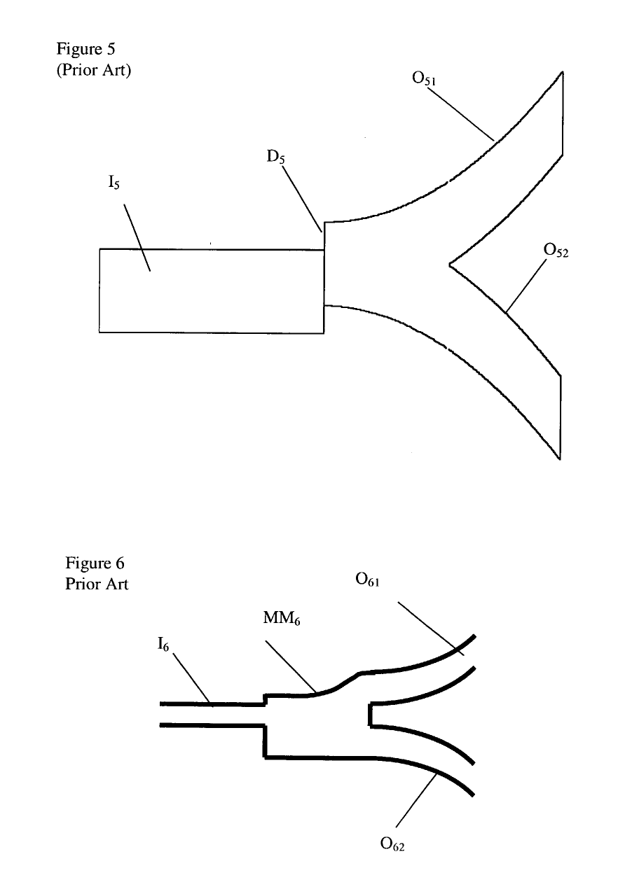

### DETAILED DESCRIPTION

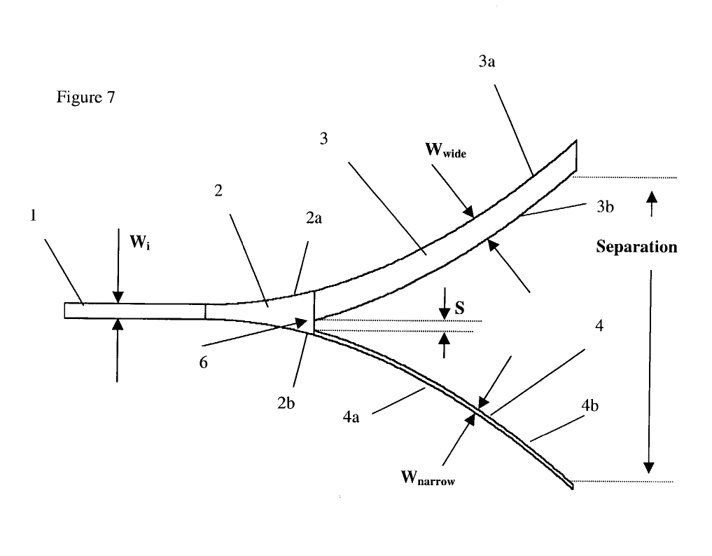

With reference to FIG. 7, the optical splitter according to the present invention includes an input waveguide 1, which is preferably designed to be mono-modal at a desired operating wavelength, e.g. 1550 nm. The input waveguide 1 has a constant mask aperture width Wi chosen so that the waveguide remains mono-mode with reduced propagation loss. In order to reduce coupling losses, the input waveguide 1 is designed with a mode approximately matching that of standard single-mode fibers.

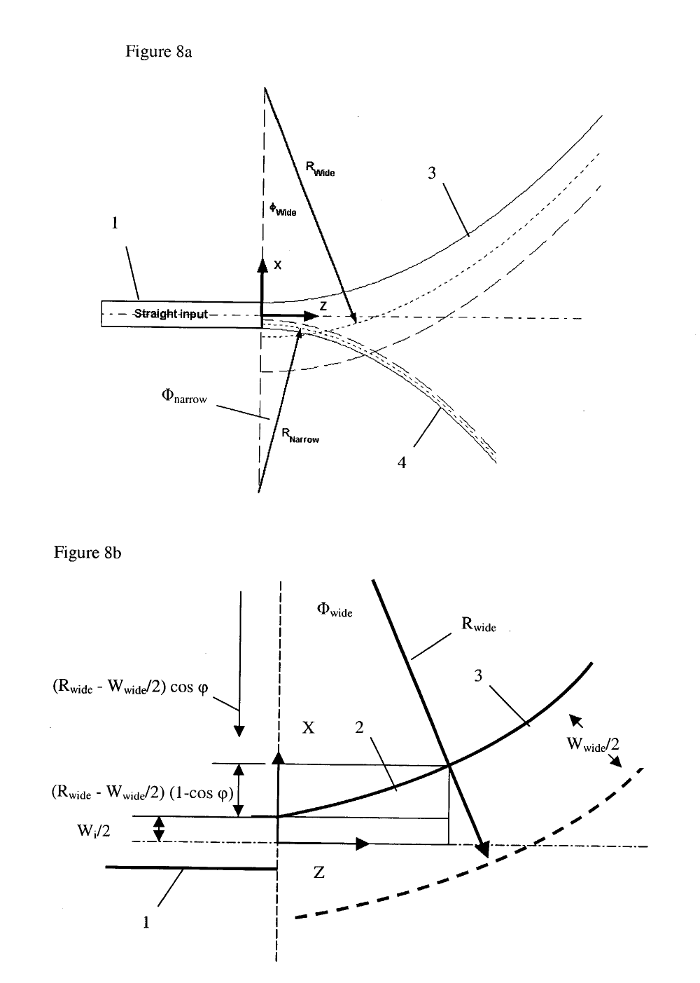

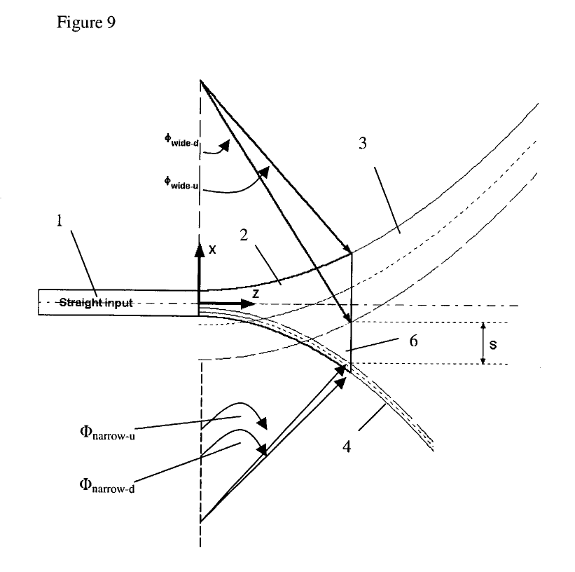

A taper section 2 forms a transition area between the input waveguide 1 and two output branching waveguides 3 and 4. With reference to FIG. 8, the shape of the taper section 2 and the output branching waveguides 3 and 4 are based on two arcs with radius R_{wide} and R_{narrow}. This arrangement does not introduce discontinuous wave front tilt, as the wave front is continually tilted along the propagation direction. Preferably, the arcs form a segment of a circle. Arcs of circles are the simplest to manufacture and provide constant radiation losses, when the radius of curvature is constant. Accordingly, since the output waveguides 3 and 4 preferably have constant widths W_{wide} and W_{narrow}, respectively, the length of the taper section 2 is defined by the size S of the truncated wedge tip 6, as will be hereinafter described. Preferably, the input waveguide 1 and the tapered section 2 are mono-modal, but the tapered section 2 may evolve gradually from mono-modal to multi-modal for the operating wavelength, e.g. 1550 nm.

The taper section 2 is defined by an extension of a first outer edge 3a of the first output waveguide 3, and a second outer edge 4a of the second output waveguide 4. In FIGS. 8a and 8b, the solid lines represent the photolithographic waveguide boundaries or edges, and the dotted lines represent the arcs of circles of radius R_{wide} and R_{narrow} extending along the longitudinal central axis of the first and second output waveguides 3 and 4, respectively. The dashed lines will be explained hereinafter. The Z-axis is defined as the longitudinal central axis of the input waveguide 1, and the X axis as the vertical axis at the junction between the input waveguide 1 and the taper section 2. The first and second outer edges 2a and 2b of the taper section 2 will be defined using parameters φ_{wide} and φ_{narrow} which designate angles between the X-axis and a line extending radially to a point on the first and second outer edges 2a and 2b, respectively, of the taper section 2.

The first outer edge 2a of the taper section 2 is defined by:

$$X = \frac{{W}_{i}}{2} + ( {R}_{wide} - \frac{{W}_{wide}}{2} ) \times ( 1 - cos {ϕ}_{wide} ) \qquad ( 1 )$$

The second outer edge 2b of the taper section 2 is defined by:

In order to completely define the taper section 2 the maximum values of φ_{wide} and φ_{narrow}

$$X = - \frac{{W}_{i}}{2} - ( {R}_{narrow} - \frac{{W}_{narrow}}{2} ) \times ( 1 - cos {ϕ}_{narrow} ) \qquad ( 2 )$$

are required, i.e. where the taper section 2 ends. As stated above, the length of the taper section 2 is dependent upon the size S of the truncated wedge tip 6. If the wedge tip 6 is not truncated, blurring of the wedge tip 6 occurs, due to limited spatial resolution of the fabrication technologies. The severity of the blurring varies depending on the deposition technology, e.g. Flame Hydrolysis Deposition, Plasma Enhanced Chemical Vapor Deposition, sol-gel, sputtering, ion-exchange, and the related photolithographic steps. Therefore, it is advantageous to intentionally truncate the wedge tip 6 in order to get reproducible results. The size of the wedge tip 6 is preferably chosen as small as possible, since large wedge tips induce higher mode mismatch between the mode in the taper section 2 and the structure modes in the two output waveguide 3 and 4, which results in higher losses. Typically, S is chosen as the smallest possible truncated wedge tip size before blurring occurs.

The distance (eventually negative) between the inner edge 3b of the first arm 3 and the inner edge 4b of the second arm 4 (the dashed lines in FIG. 8) is:

When this distance equals S (S is a positive quantity), the position at which the taper

$$\begin{matrix}\frac{{W}_{i}}{2} - {W}_{wide} + ( {R}_{wide} + \frac{{W}_{wide}}{2} ) \times ( 1 - cos {ϕ}_{wide} ) - [ - \frac{{W}_{i}}{2} +\end{matrix} \begin{matrix}{W}_{narrow} - ( {R}_{narrow} + \frac{{W}_{narrow}}{2} ) \times ( 1 - cos {ϕ}_{narrow} ) ]\end{matrix} \qquad ( 3 )$$

section 2 ends is determined. This gives a first relationship between the two quantities φ_{wide}_{_{—}}_{d} and φnarrow_{_{—}}ᵤ as:

$$( {R}_{wide} + \frac{{W}_{wide}}{2} ) \times cos {ϕ}_{wide\_d} + ( {R}_{narrow} + \frac{{W}_{narrow}}{2} ) \times cos {ϕ}_{narrow\_u} = {R}_{wide} + {R}_{narrow} + {W}_{i} - \frac{{W}_{wide} + {W}_{narrow}}{2} - S \qquad ( 4 )$$

A second relationship between φ_{wide}_{_{—}}_{d} and φ_{narrow}_{_{—}}ᵤ is:

$$( {R}_{wide} + \frac{{W}_{wide}}{2} ) \times sin {ϕ}_{wide\_d} = ( {R}_{narrow} + \frac{{W}_{narrow}}{2} ) \times sin {ϕ}_{narrow\_u} \qquad ( 5 )$$

By combining (4) and (5), we obtain a system of two equations with two unknowns, φ_{wide}_{_{—}}_{d} and φ_{narrow}_{_{—}}ᵤ:

$$\{ \begin{matrix}\begin{matrix}\begin{matrix}\begin{matrix}\begin{matrix}\begin{matrix}α cos {ϕ}_{wide\_d} + β cos {ϕ}_{narrow\_u} = {λ}_{1} \\ {α }^{2} {cos}^{2} {ϕ}_{wide\_d} - {β }^{2} {cos}^{2} {ϕ}_{narow\_u} = {λ}_{2}\end{matrix} \\ with :\end{matrix} \\ α = {R}_{wide} + \frac{{W}_{wide}}{2}\end{matrix} \\ β = {R}_{narrow} + \frac{{W}_{narrow}}{2} ,\end{matrix} \\ {λ}_{1} = {R}_{wide} + {R}_{narrow} + {W}_{i} - \frac{{W}_{wide} + {W}_{narrow}}{2} - S\end{matrix} \\ {λ}_{2} = {( {R}_{wide} + \frac{{W}_{wide}}{2} )}^{2} - {( {R}_{narrow} + \frac{{W}_{narrow}}{2} )}^{2} = {α}^{2} - {β}^{2}\end{matrix}$$

This system is readily solved in:

$$\begin{matrix}{ϕ}_{wide\_d} = arccos ( \frac{{λ}_{1}^{2} + {λ}_{2}}{2 α {λ}_{1}} ) & ( 7 ) \\ {ϕ}_{narrow\_u} = arccos ( \frac{{λ}_{1}^{2} - {λ}_{2}}{2 β {λ}_{1}} ) & ( 8 )\end{matrix}$$

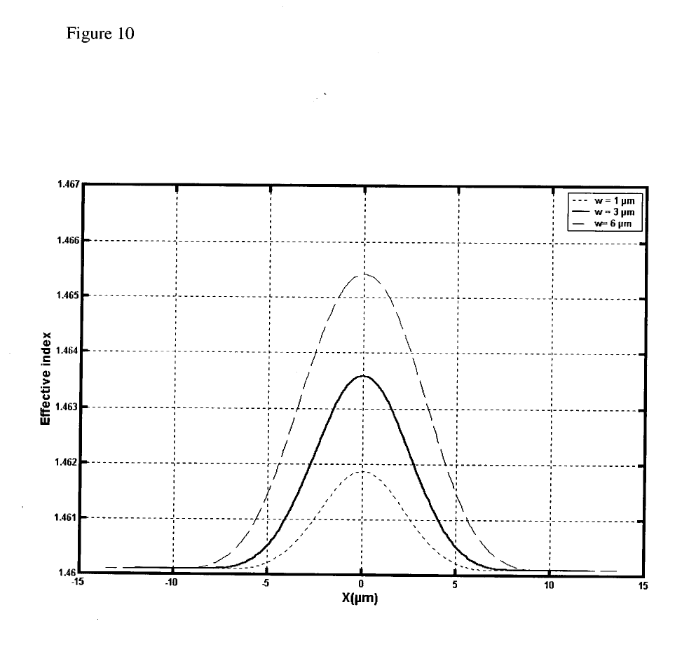

In order to define the taper section 2, the angles φ_{wide}_{_{—}}ᵤ and φ_{narrow}_{_{—}}_{d} are required. Geometrical considerations based on FIG. 10 yield:

(α−W_{wide})×(1−cos φ_{wide}_{_{—}}ᵤ)=α(1−cos φ_{wide}_{_{—}}_{d}) (9)

β−W_{narrow})×(1−cos φ_{wide}_{_{—}}_{d})=β(1−cos φ_{narrow}_{_{—}}ᵤ (10)

From (9) and (10), we get φ_{wide}_{_{—}}ᵤ and φ_{narrow}_{_{—}}_{d} as a function of φ_{wide}_{_{—}}_{d} and φ_{narrow}_{_{—}}_{u,} which are themselves given by (7) and (8):

$$\begin{matrix}{ϕ}_{wide\_u} = arccos ( \frac{α cos {ϕ}_{wide\_d} - {W}_{wide}}{α - {W}_{wide}} ) & ( 11 ) \\ {ϕ}_{narrow\_d} = arccos ( \frac{{βcosϕ}_{narrow\_u} - {W}_{narrow}}{β - {W}_{narrow}} ) & ( 12 )\end{matrix}$$

The taper section 2 is now completely defined, i.e. the first outer edge 2a is-defined by equation (1), where φ_{wide} runs between 0 and φ_{wide}_{_{—}}ᵤ. The quantity φ_{wide}_{_{—}}ᵤ is defined in equation (11), where a is defined in equation (6) and φ_{wide}_{_{—}}_{d} in equation (7). The second outer edge 2b of the taper section 2 is defined by equation (2), where φ_{narrow} runs between 0 and φ_{narrow}_{_{—}}_{d}. The quantity φ_{narrow}_{_{—}}_{d} is defined in equation (12), where β is defined in equation (6) and φ_{narrow}_{_{—}}ᵤ in equation (8).

The respective edges of the output waveguides 3 and 4 have been defined above; however, the position of the ends thereof still has not been determined. In the aforementioned prior art references, several authors have shown that the optical power bounces back and forth between the two output branching arms before the splitting ratio stabilizes. This stabilization occurs when the two waveguides are separated by a distance such that they can be considered to be uncoupled. In other words, the effective indices of the symmetric and anti-symmetric modes of the two-waveguides structure are equal to the effective indices of the two ideally isolated waveguides. This required separation distance can be numerically simulated. Once it has been chosen, the angles at which the two output branching waveguides 3 and 4 end can be calculated with a similar procedure as the one used to find φ_{wide}_{_{—}}ᵤ, φ_{wide}_{_{—}}_{d}, φ_{narrow}_{_{—}}ᵤ and φ_{narrow}_{_{—}}_{d} by replacing S with the desired value of the separation distance.

The parameters Wᵢ, R_{wide}, R_{narrow}, W_{wide}, W_{narrow}, S, and Separation completely define the optical splitter according to the present invention. These seven parameters can be chosen independently, making the structure very flexible, in order to obtain a stable splitting ratio, with low wavelength and polarization dependence and low loss.

The two output branches 3 and 4 can be subsequently tapered to another width (usually Wᵢ) if the losses introduced by widening or narrowing the width are too high. This structure can be further integrated with other structures, like other splitters for example.

Experimental Results

Experimental results based on waveguides made by ion-exchange and designed with the principle disclosed in the present invention are detailed below.

The parameters are: R_{wide}=R_{narrow}=100 mm, S=0.5 μm, Separation=30 μm, and Wi=3 μm. The parameters W_{narrow} and W_{wide} are varied, as explained below. With this set of parameters, the angle between the two output branches varies between −16 mrad and −38 mrad. The small values of the angle reduces the loss.

Typically, ion-exchange is a two-step diffusion process that can be simulated by numerical integration of diffusion equations. The simulation yields a two-dimensional refractive index profile for a given mask aperture. By using the effective index method, it is possible to transform this two-dimensional profile in a one-dimensional effective index profile. Some examples of such profiles of straight waveguides with different mask apertures are given in FIG. 10, which correspond to the experimental conditions.

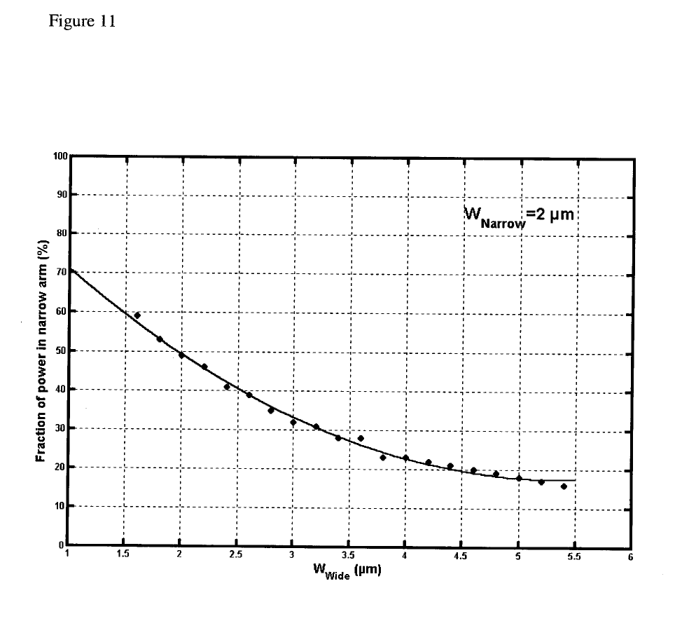

An investigation into the capability of the optical splitter according to the present invention to produce a given splitting ratio was conducted. For that purpose, a series of asymmetric splitters were designed with W_{narrow}=2 μm and W_{wide} being variable. The results are shown in FIG. 11, where the splitting ratio is given at 1550 nm. Accordingly, it is possible to build optical splitter having splitting ratios between 50:50 and 83:17.

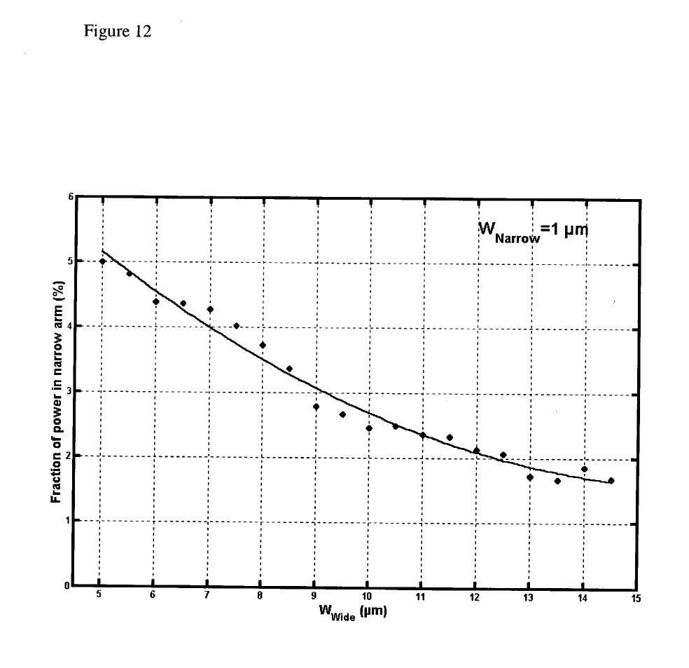

However, for monitoring applications, splitting ratios lower than 17% may be required. Therefore, a second experiment was conducted in which W_{narrow} was fixed at 1 μm and W_{wide} varied over a wider range. The results are shown in FIG. 12. Accordingly, splitting ratios as low as 98.3:1.7 are achievable. The curve of splitting-ratio-as-a-function-of-W_{wide} is of the exponential decay type. Therefore, the derivative of this curve, which is the sensitivity of the splitting ratio on the photolithographic resolution can be tuned for a given desired splitting ratio by adjusting W_{narrow}.

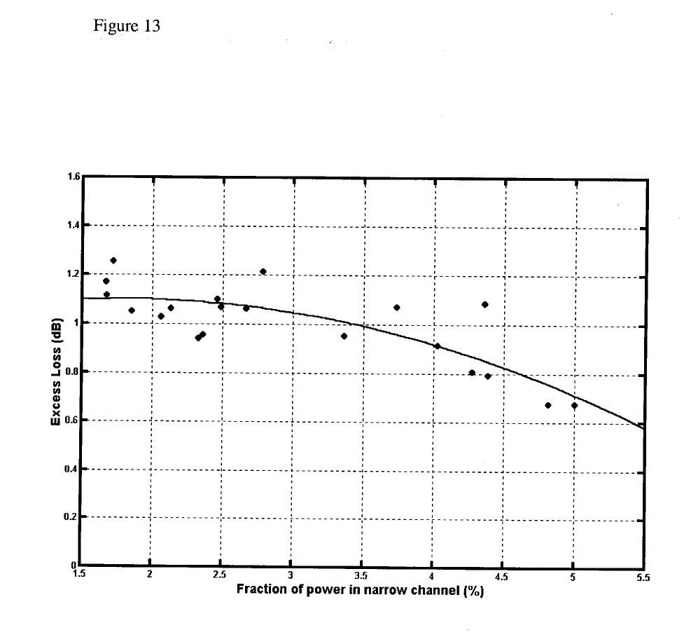

The second important parameter is the excess loss, which is defined as the difference between the power injected in the input waveguide 1 and the sum of the powers in the two output waveguide branches 3 and 4, the whole being normalized to the input power. The results are shown in FIG. 13. A reasonable value of ˜1 dB excess loss is achieved. The excess loss slightly increases with the asymmetry of the splitter.

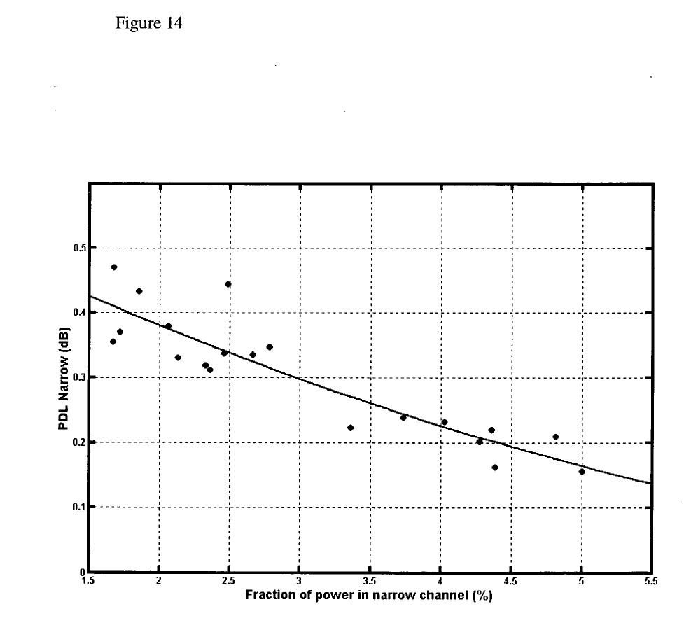

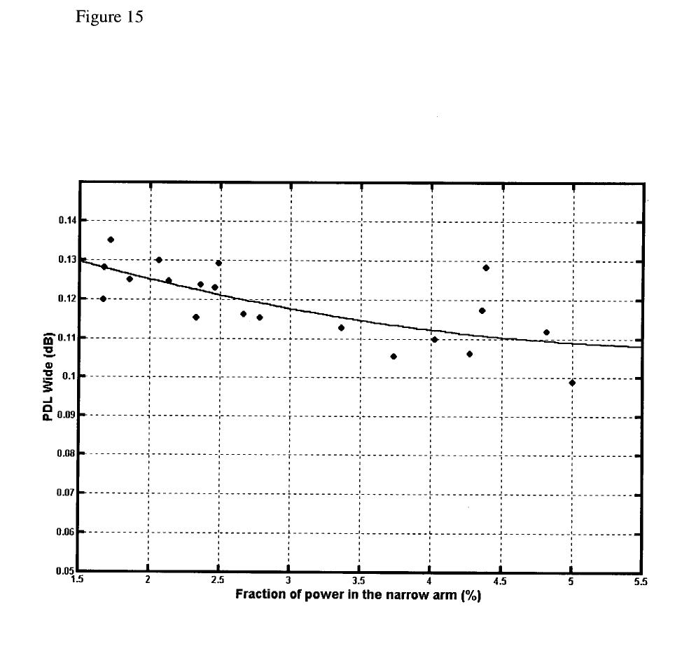

The next parameter under study is the Polarization Dependent Loss (PDL). The PDL in the narrow arm (FIG. 14) slightly increases with the splitter asymmetry, but remains in a reasonable range. The PDL in the wide arm (FIG. 15) stays fairly constant with the splitter asymmetry and is lower than in the narrow arm.

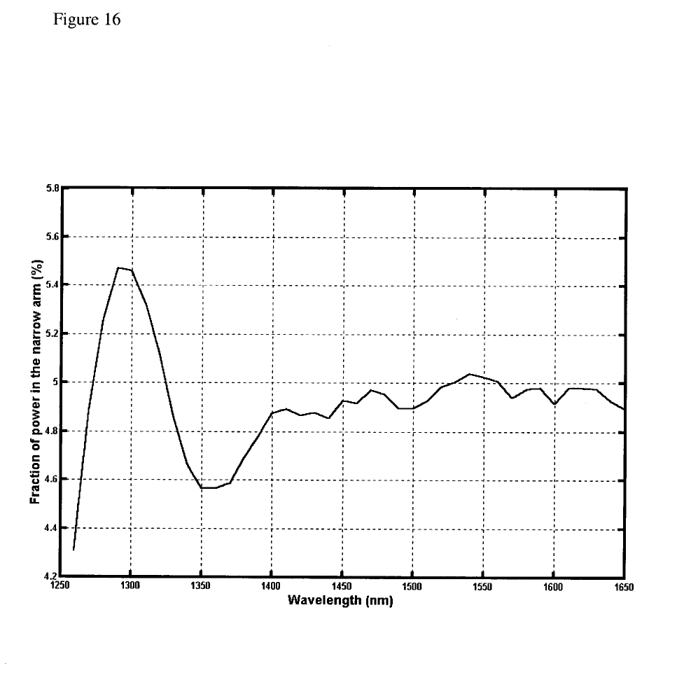

The Wavelength Dependent Loss (WDL) is shown in FIG. 16. A sample with Wᵢ=3 μm, W_{wide}=5 μm, and W_{narrow}=1 μm was characterized. The splitting ratio is shown to vary between ˜4.3% and ˜5.3% over 1260-1650 nm. The wideband operation is therefore demonstrated.

We claim:

1. An integrated optical splitter device comprising:
an input waveguide for launching an optical signal defined by a wave front;
a first output waveguide for outputting a first portion of the optical signal, the first output waveguide having a first width;
a second output waveguide having a second width for outputting a second portion of the optical signal, the second output waveguide having a second width less than the first width;
a tapered section having an input end coextensive with an end of the input waveguide, and an output end optically coupled to the first and second output waveguides, the output end of the tapered section being wider than the first and the second waveguides combined forming a truncated wedge tip therebetween;
wherein a first outer edge of the tapered section and an outer edge of the first output waveguide define a first arc; and
wherein a second outer edge of the tapered section and an outer edge of the second output waveguide define a second arc;
whereby the wave front is continually tilted during propagation through the device.

2. The device according to claim 1, wherein the input waveguide and the tapered section are mono-modal at an operating wavelength.

3. The device according to claim 2, wherein the mode of the input waveguide is substantially matched to that of a standard single-mode optical fiber.

4. The device according to claim 1, wherein the input waveguide is mono-modal for an operating wavelength, and the tapered section evolves gradually from mono-modal to multi-modal for the operating wavelength.

5. The device according to claim 1, wherein the first arc is a segment of a circle.

6. The device according to claim 5, wherein the second arc is a segment of a circle.

7. The device according to claim 6, wherein a first outer edge of the tapered section and the first output waveguide is defined by a distance X from a longitudinal central axis extending through the input waveguide and the tapered section;
wherein
$$X = \frac{{W}_{i}}{2} + ( {R}_{wide} - \frac{{W}_{wide}}{2} ) \times ( 1 - cos {ϕ}_{wide} ) \qquad ( 1 )$$
in which:
Wᵢ=width of the input waveguide
R_{wide}=radius of the first arc
W_{wide}=width of the first output waveguide
Φ_{wide}=angle between radially extending vertical line and radially extending line to point X.

8. The device according to claim 7, wherein a second outer edge of the tapered section and the second output waveguide is defined by a distance X from the longitudinal central axis extending through the input waveguide and the tapered section;
wherein
$$X = - \frac{{W}_{i}}{2} - ( {R}_{narrow} - \frac{{W}_{narrow}}{2} ) \times ( 1 - cos {ϕ}_{narrow} ) \qquad ( 2 )$$
in which:
Wᵢ=width of the input waveguide
R_{narrow}=radius of the second arc
W_{narrow}=width of the second output waveguide
Φ_{narrow}=angle between radially extending vertical line and radially extending line to point X.

9. The device according to claim 1, wherein the input waveguide has a substantially constant width, which is greater than the second width.

10. The device according to claim 1, wherein the first output waveguide has a substantially constant width.

11. The device according to claim 10, wherein the second output waveguide has a substantially constant width.

12. The device according to claim 11, wherein the width of the first output waveguide is 2 to 14 times wider than the width of the second output waveguide.

13. The device according to claim 11, wherein the width of the first output waveguide is 5 to 14 times wider than the width of the second output waveguide.
